(19) United States
(12) Patent Application Publication
(10) Pub. No.: US 2011/0220770 A1
(43) Pub. Date: Sep. 15, 2011

(54) MOUNTING APPARATUS FOR DISK DRIVE

(75) Inventor: ZHENG-HENG SUN, Tu-Cheng (TW)

(73) Assignee: HON HAI PRECISION INDUSTRY CO., LTD., Tu-Cheng (TW)

(21) Appl. No.: 12/764,991

(22) Filed: Apr. 22, 2010

(30) Foreign Application Priority Data
Mar. 12, 2010 (CN) 201010123352.8

(51) Int. Cl. F16M 13/00

(52) U.S. Cl. 248/309.1

(57) ABSTRACT

A mounting apparatus is configured for securing a disk drive. The disk drive defines a locking hole. The mounting apparatus includes a bracket, a locking component and a spring member. The bracket includes a chassis side wall defining a through hole. Two pivot pieces are located on the chassis side wall. Two pivot pins are disposed on the locking component and rotatably engaged with the pivot piece. A locking tab is located on the locking component. The locking component defines a holding opening. One of the pivot pins is positioned in the holding opening. The spring member is secured on the one pivot pin, which is positioned in the holding opening. The locking component is rotatable between a locked position, where the locking tab is engaged in the locking hole of the disk drive, and an unlocked position, where the locking tab is disengaged from the locking hole.

### BACKGROUND

1. Technical Field

The present disclosure relates to a mounting apparatus for a disk drive.

2. Description of Related Art

A conventional means for securing a disk drive to a bracket of a computer chassis is by screws. This is very inconvenient.

### BRIEF DESCRIPTION OF THE DRAWINGS

Many aspects of the embodiments can be better understood with references to the following drawings. The components in the drawings are not necessarily drawn to scale, the emphasis instead being placed upon clearly illustrating the principles of the embodiments. Moreover, in the drawings, like reference numerals designate corresponding parts throughout the several views.

FIG. 1 is a partly exploded view of a mounting apparatus and a disk drive in accordance with an embodiment.

FIG. 2 is an isometric view of a locking component and a spring member of the mounting apparatus of FIG. 1.

FIG. 3 is similar to FIG. 1, but showing the locking components and the spring members secured to a bracket.

FIG. 4 is an assembled view of the mounting apparatus and the disk drive of FIG. 1, and shows the locking components in an unlocked position.

FIG. 5 is an enlarged view of portion V of FIG. 4.

FIG. 6 is similar to FIG. 4, but showing the locking components in a locked position.

FIG. 7 is an enlarged view of portion VII of FIG. 6.

### DETAILED DESCRIPTION

The disclosure is illustrated by way of example and not by way of limitation in the figures of the accompanying drawings in which like references indicate similar elements. It should be noted that references to “an” or “one” embodiment in this disclosure are not necessarily to the same embodiment, and such references mean at least one.

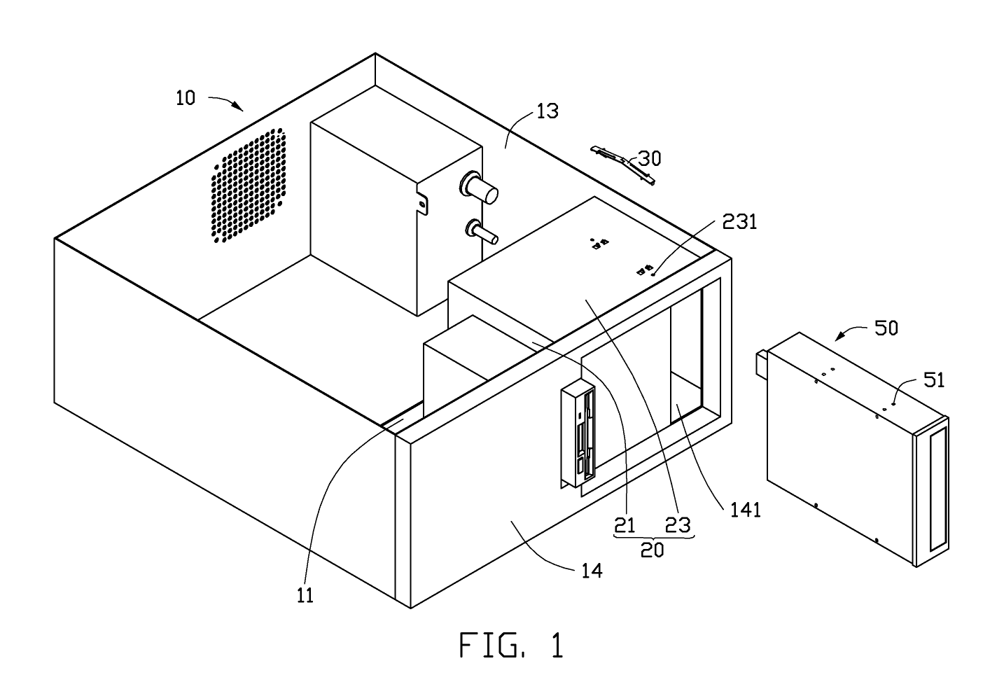

Referring to FIG. 1, a mounting apparatus in accordance with an embodiment includes a bracket 20 configured for receiving a disk drive 50, and two locking components 30 configured to secure the disk drive 50 in the bracket 20. The disk drive 50 defines a plurality of locking holes 51 in two opposite sidewalls of the disk drive 50.

The bracket 20 is mounted in a chassis 10. The chassis 10 includes a chassis sidewall 11, a chassis top wall 13 and a chassis front wall 14 jointly connected to each other. In an embodiment, the chassis sidewall 11, the chassis top wall 13 and the chassis front wall 14 are substantially perpendicular to each other. The chassis front wall 14 defines a through opening 141. In an embodiment, the bracket 20 is secured to the chassis top wall 13 and the chassis front wall 14.

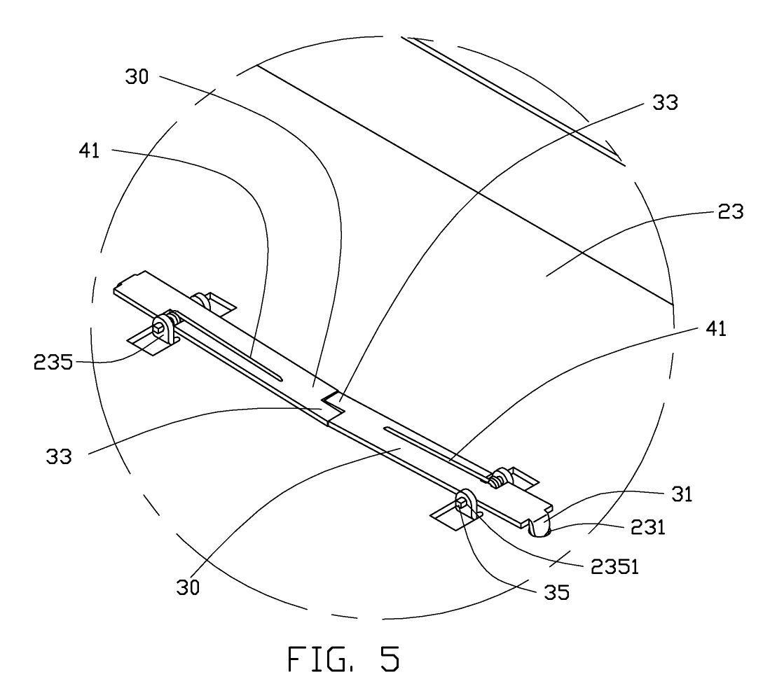

The bracket 20 includes chassis side wall 23 and a chassis bottom wall 21 connected to the chassis side wall 23. In an embodiment, the chassis bottom wall 21 is substantially perpendicular to the chassis side wall 23. The chassis side wall 23 defines two through holes 231. Two pairs of pivot pieces 235 (see FIG. 5) are located on the top wall 23, adjacent the two through holes 231. Each pivot piece 235 defines a pivot hole 2351 (see in FIG. 5).

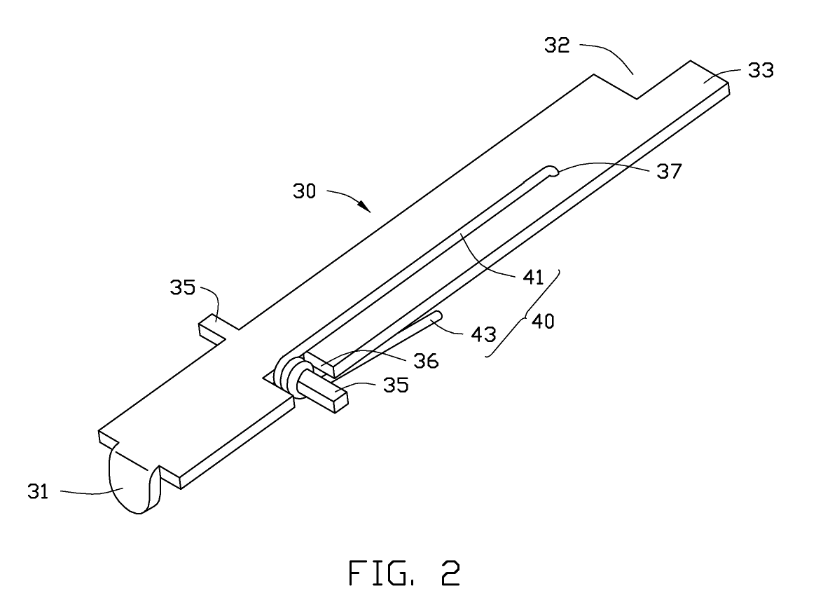

Referring to FIG. 2, each locking component 30 includes a locking tab 31 located at one end of the locking component 30. The locking tab 31 can be inserted through the through hole 231 and extended into the bracket 20. A cutout 32 is defined in an opposite end of each locking component 30, and an extending portion 33 is thereby formed on the opposite end. A holding opening 36 is defined in each locking component 30. Two pivot pins 35 extend from each locking component 30, and one of the pivot pin 35 is positioned in the holding opening 36. A securing hole 37 is defined in each locking component 30.

A spring member 40 is disposed on the one pivot pin 35, which is in the holding opening 36. The spring member 40 includes a first leg 41 and a second leg 43. The first leg 41 is engaged in the securing hole 37 of the locking component 30.

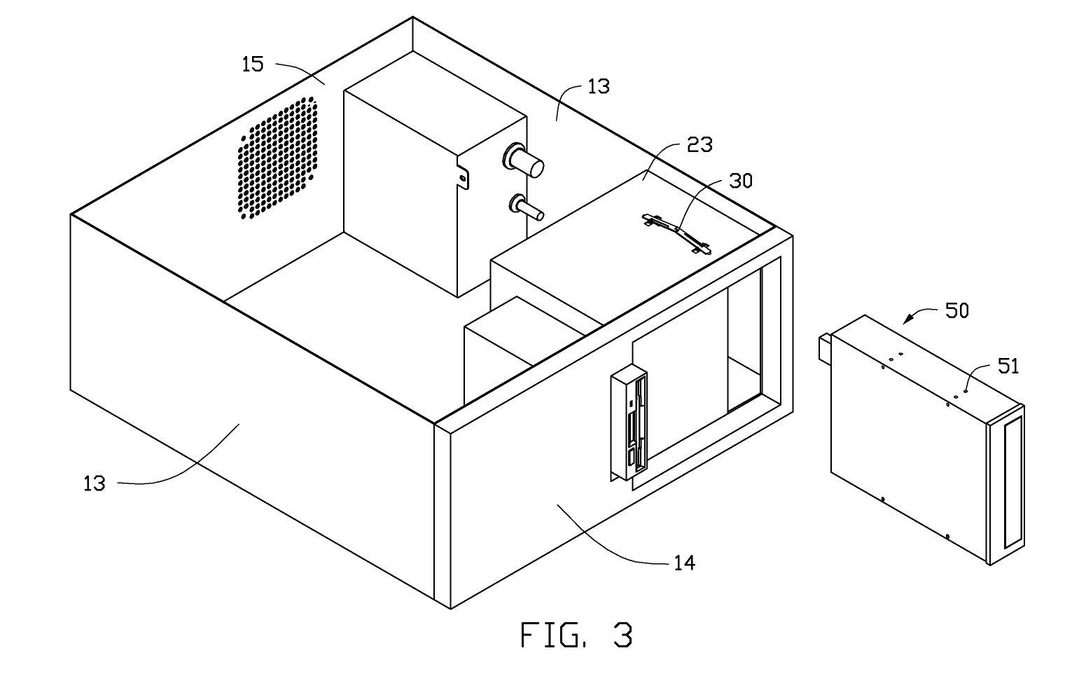

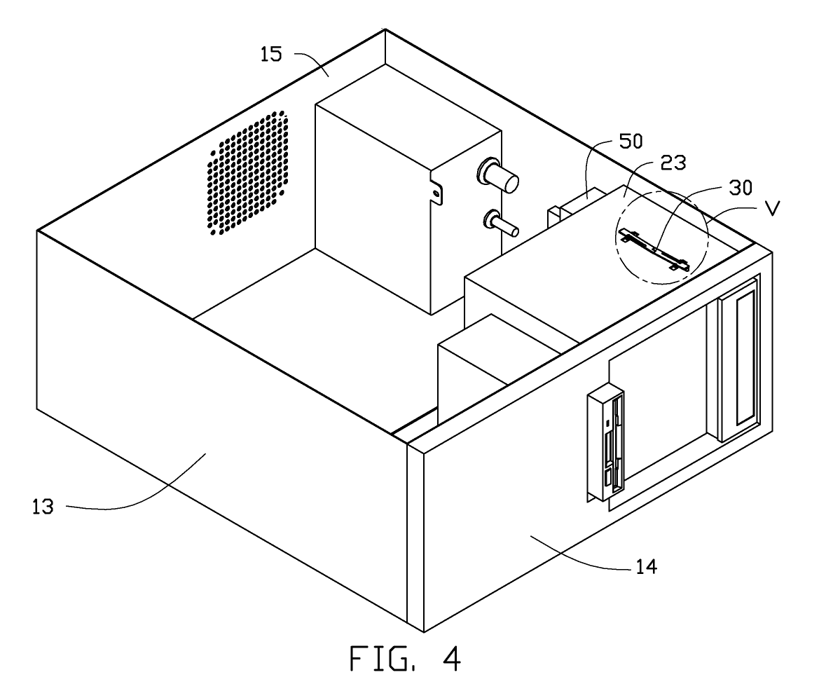

Referring to FIGS. 3-5, the pivot pins 35 of the locking components 30 are received in the pivot holes 2351 of the pivot pieces 235, to pivotably secure the locking components 30 on the bracket 20. The locking tabs 31 correspond to the through holes 231 of the chassis side wall 23. The second end 43 abuts the chassis side wall 23. The extending portion 33 of one locking component 30 is engaged in the cutout 33 of the other locking component 30.

In use, before securing the disk drive 50 in the bracket 20, each locking component 30 has a locked position, where the spring members 40 have an original state and the locking tabs 31 are engaged in the corresponding through holes 231 and extended into the bracket 20, to block the disk drive 50 from insertion in the bracket 20. In an embodiment, the extending portions 33 of the locking components 30 is away from the chassis side wall 23 when the locking components 30 are in the locked position.

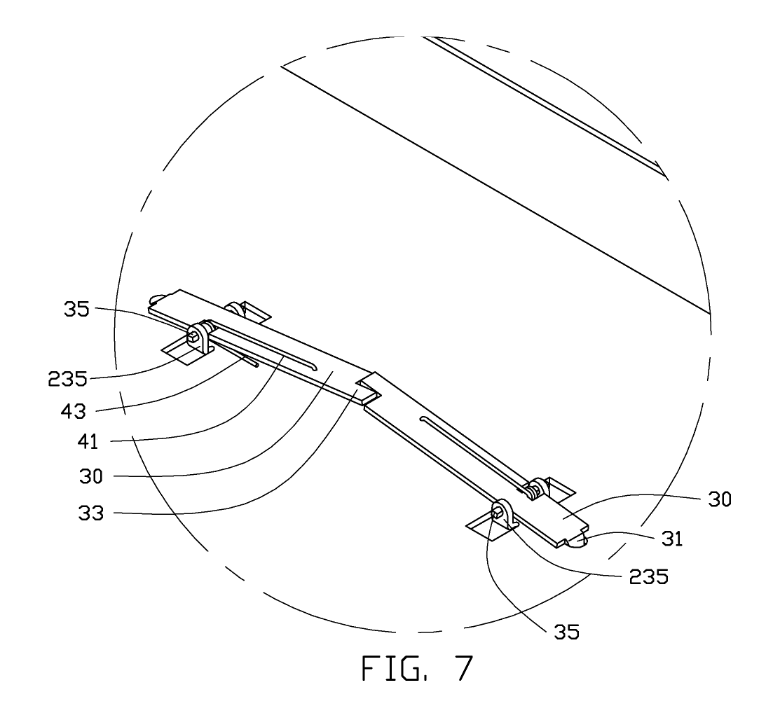

Referring to FIGS. 3 and 7, in assembly of the disk drive 50, each locking component 30 is rotated by pressing from the locked position to an unlocked position. The spring members 40 are resiliently deformed, and the locking tabs 31 are positioned outside of the bracket 20, or engaged in the through holes 231, but cannot block the disk drive 50 from being inserted into the bracket 20. Therefore, the disk drive 50 can be inserted in the bracket 20 via the through opening 141. In an embodiment, the extending portions 33 of the locking components 30 abut the chassis side wall 23.

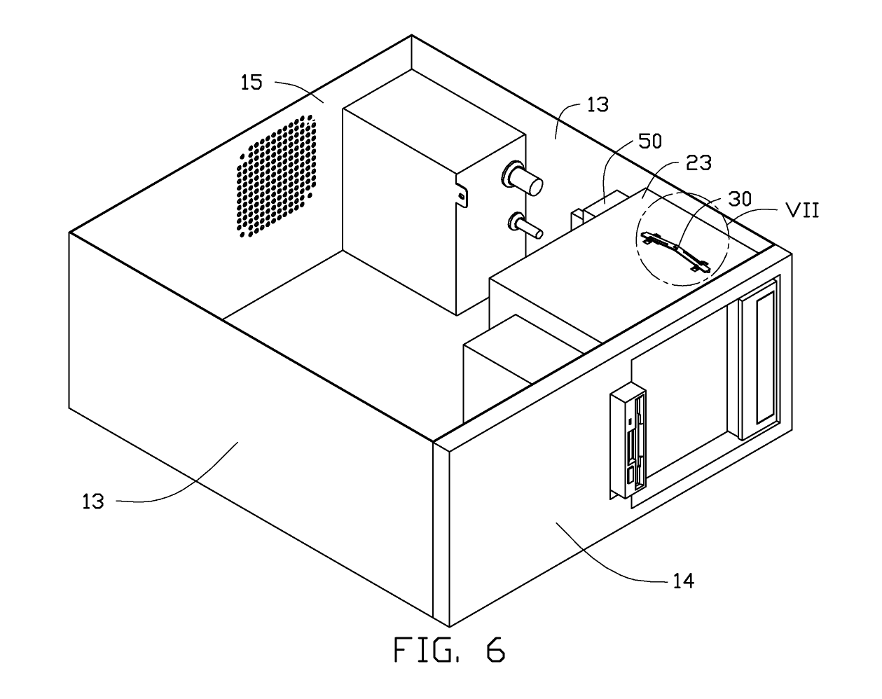

Referring to FIGS. 6-7, when the locking holes 51 of the disk drive 50 align with the through holes 231 of the chassis side wall 23, the locking components 30 are released. The spring members 40 return to the original state, to rotate the locking components 30 from the unlocked position to the locked position. The locking tabs 31 are engaged into the locking holes 51, to secure the disk drive 50 in the bracket 20.

In removal of the disk drive 50, the locking components 30 are rotated from the locked position to the unlocked position, to disengage the locking tabs 31 from the locking holes 51 of the disk drive 50. Therefore, the disk drive 50 can be removed from the bracket 20.

It is to be understood, however, that even though numerous characteristics and advantages have been set forth in the foregoing description of embodiments, together with details of the structures and functions of the embodiments, the disclosure is illustrative only and changes may be made in detail, especially in matters of shape, size, and arrangement of parts within the principles of the disclosure to the full extent indicated by the broad general meaning of the terms in which the appended claims are expressed.

What is claimed is:

1. A mounting apparatus for a disk drive with a locking hole, the mounting apparatus comprising:
a bracket comprising a chassis side wall, the chassis side wall defining a through hole, two pivot pieces located on the chassis side wall;
a locking component, two pivot pins disposed on the locking component and rotatably engaged with the pivot piece, a locking tab located on the locking component; the locking component defining a holding opening; one of the pivot pins positioned in the holding opening; and
a spring member secured on the one pivot pin, which is positioned in the holding opening;
wherein the locking component is rotatable between a locked position, where the locking tab is inserted through the through hole and extended into the bracket for engaging in the locking hole of the disk drive and the spring member is in an original state, and an unlocked position, where the locking tab is located for being disengaged from the locking hole and the spring member has a resilient deformation greater than that in the original state.

2. The mounting apparatus of claim 1, wherein the locking component defines a securing hole; and the spring member comprises a first leg secured in the securing hole.

3. The mounting apparatus of claim 2, wherein the spring member further comprises a second leg abutting the chassis side wall.

4. The mounting apparatus of claim 3, wherein the locking component is positioned between the first leg of the spring member and the chassis side wall.

5. The mounting apparatus of claim 1, wherein the locking tab is located on one end of the locking component, and a other end of the locking component defines a cutout.

6. The mounting apparatus of claim 5, wherein an extending portion is disposed on the other end of the locking component and abuts the chassis side wall when the locking component is in the unlocked position.

7. A mounting apparatus for a disk drive, the mounting apparatus comprising:
a bracket defining two through holes;
two locking component, two pivot pins disposed on each locking component and rotatably engaged with the bracket, a locking tab located on each of the locking component; each of the locking components defining a holding opening; one of the pivot pins positioned in the holding opening; and
two spring members, each spring member secured on the one pivot pin, which is positioned in the holding opening;
wherein the locking tabs are inserted in the through holes and extended in the bracket for engaging in two locking holes defined n the disk drive when each spring member is in an original state.

8. The mounting apparatus of claim 7, wherein each of the locking components defines a securing hole; and each of the spring members comprises a first leg secured in the securing hole.

9. The mounting apparatus of claim 8, wherein each of the spring members further comprises a second leg abutting the chassis side wall.

10. The mounting apparatus of claim 8, wherein each locking component is positioned between the first leg of the spring member and the chassis side wall.

11. The mounting apparatus of claim 7, wherein the locking tab is located on one end of each locking component, and a other end of each locking component defines a cutout.

12. The mounting apparatus of claim 11, wherein an extending portion is disposed on the other end of each locking component; and the extending portion of one locking component is engaged in the cutout of the other locking component.

13. The mounting apparatus of claim 12, wherein the extending portion of each locking component abuts the chassis side wall when the locking component is in the unlocked position.
